(19) United States
(12) Patent Application Publication
(10) Pub. No.: US 2024/0256841 A1
(43) Pub. Date: Aug. 1, 2024

(54) INTEGRATION OF A GENERATIVE MODEL INTO COMPUTER-EXECUTABLE APPLICATIONS

(71) Applicant: Microsoft Technology Licensing, LLC, Redmond, WA (US)

(72) Inventors: Bradley Moore ABRAMS, Redmond, WA (US); Mridu Baldevraj NARANG, Redmond, WA (US); Chengyu PENG, Seattle, WA (US); Zhangwei WU, Redmond, WA (US); Hariharan RAGUNATHAN, Woodinville, WA (US); Parul PURI, Redmond, WA (US); Alyssa RICKEN, Redmond, WA (US)

(21) Appl. No.: 18/335,998

(22) Filed: Jun. 15, 2023

Related U.S. Application Data
(60) Provisional application No. 63/442,448, filed on Jan. 31, 2023.

(51) Int. Cl. G06N 3/0475; G06F 16/9538

(52) U.S. Cl. CPC G06N 3/0475; G06F 16/9538

(57) ABSTRACT

A computing system described herein includes a processor and memory storing instructions that, when executed by the processor, cause the processor to perform several acts. The acts include generating a prompt that is to be input to a generative language model, where the prompt includes content of a webpage being presented to the user. The acts also include providing the prompt as input to the generative language model. The acts further include receiving output from the generative language model, where the generative language model generated the output based upon the prompt. The acts additionally include causing the output to be presented to the user by way of a client computing device concurrently with the webpage being presented to the user.

### RELATED APPLICATION

This application claims priority to U.S. Provisional Patent Application No. 63/442,448, filed on Jan. 31, 2023, and entitled “INTEGRATION OF GENERATIVE LANGUAGE MODEL INTO COMPUTER-EXECUTABLE APPLICATIONS”. The entirety of this application is incorporated by reference.

### BACKGROUND

Relatively recently, generative models, such as generative language models (GLMs) (also referred to as large language models (LLMs)) have been developed. An example of a GLM is the Generative Pre-trained Transformer 3 (GPT-3). Another example of a GLM is the BigScience Language Open-science Open-access Multilingual (BLOOM) model, which is also a transformer-based model. Briefly, a generative model is configured to generate an output (such as text in human language, source code, music, video, and the like) based upon a prompt set forth by a user and in near real-time (e.g., within a few seconds of receiving the prompt). The generative model generates content based upon training data over which the generative model has been trained. Accordingly, in response to receiving the prompt “how many home runs did Babe Ruth bit before he turned 30”, a GLM can output “Before he turned 30, Babe Ruth hit 94 home runs.” In another example, in response to receiving the prompt “provide me with a list of famous people born in Seattle and Chicago”, the GLM can output two separate lists of people (one for Seattle and one for Chicago), where the list of people born in Chicago includes Barrack Obama. In both these examples, however, the GLM outputs information that is incorrect-for instance, Babe Ruth hit more than 94 home runs before he turned 30, and Barrack Obama was born in Hawaii (and not Chicago). Accordingly, both conventional search engines and generative models are deficient with respect to identifying and/or generating appropriate information in response to certain types of user input.

In addition, GLMs are not well-suited to provide accurate answers to user input that pertains to recent information. For instance, a GLM, upon receipt of input “what is the current weather in Chicago,” is unable to provide accurate output, as the GLM generates textual output based upon training data which tends to be at least somewhat stale (i.e., it is impractical to retrain a GLM every minute with updated information about weather, sporting events, stock markets, news events, and so forth).

### SUMMARY

The following is a brief summary of subject matter that is described in greater detail herein. This summary is not intended to be limiting as to the scope of the claims.

Various technologies are described herein that relate to integrating a generative model (such as a GLM) with applications, such that the generative model is provided with input from the applications and generates output based upon such input. This integration addresses several deficiencies of generative models referenced above; in an example, a web browser can be configured to have a side panel, where the side panel includes features that can be employed to interact with the generative model. For public pages, the generative model is provided with content of such pages and/or metadata pertaining to such pages, and this information can be used as a portion of a prompt and/or can be used by the generative model to provide suggestions. For example, when a webpage loaded by the web browser is a relatively long news article, the generative model is provided with such news article by way of the web browser and outputs a suggestion, such as “would you like me to summarize this article”, which is presented on the web browser by way of the side panel. Upon receiving an indication that the user desires to have the article summarized, the generative model generates a summary of the article and presents such summary by way of the side panel.

In another example, the web browser may have a webpage loaded therein that includes private information, such as an email page, a social media page, an enterprise page, or the like. In such an example, the web browser can receive an indication that the user wishes to interact with the generative model by way of the side panel. The web browser can ascertain that the page is a “private” page (e.g., based upon the page not being indexed by a search engine, for example), and can present a request for consent to the user; thus, the content of the private page is not provided to the generative model unless explicit user consent is received. Upon receiving such consent, the generative model is provided with access to content of the webpage and can generate output based upon content of the webpage (e.g., where the output is conversational in nature).

In still yet another example, a web browser can have several open tabs, with each tab having a webpage loaded therein. The generative model can be provided with URLs for the webpages loaded in the tabs, times that the webpages were last viewed by the user, amongst other information. The generative can receive input such as “make active the browser tab that I was viewing about thirty minutes ago” and can identify which tab was active in the web browser approximately thirty minutes prior to the input being received. This feature may be particularly beneficial for voice input, allowing for the user to quickly switch between tabs based upon conversational input.

In still yet another example, an operating system is configured to have a pinnable side panel, thereby providing permanent access to a generative model regardless of the application that is being used by a user. Thus, a user can be employing a word processing document that includes content and can relatively quickly copy and paste content from the word processing document to an input field in the side panel; the generative model is provided with such content, and can summarize the content, rewrite the content, generate an image based upon the content, generate video based upon the content, and so forth. Additionally, the operating system can provide the generative model with information about the application that is open (e.g., identity of the application, type of the application, etc.), and the generative model can use such information to generate output (e.g., conversational output, an image, and so forth). Put differently, the information about the application is included in the prompt provided to the generative model, and the generative model generates output based upon the prompt.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of a computing environment where a web browser includes a side panel by way of which a generative model can be interacted with by a user.

FIG. 2 is a communications diagram that depicts flow of communications between a browser, a web server, an interface module, a generative model, and a search engine.

FIG. 3 is a graphical user interface of a webpage having a side panel by way of which a user is able to interact with a generative model.

FIG. 4 is a GUI of a webpage having a side panel by way of which a user is able to interact with a generative model.

FIG. 5 is a communications diagram that depicts flow of communications between a browser, a web server, an interface module, and a generative model.

FIG. 6 is a GUI of a webpage having a side panel by way of which a user is able to interact with a generative model.

FIG. 7 is a GUI of a webpage having a side panel by way of which a user is able to interact with a generative model.

FIG. 8 is a functional block diagram of a computing environment that supports user interaction with a generative model by way of a side panel presented by an operating system of a client computing device.

FIG. 9 is a communications diagram that illustrates flow of communications between an operating system, an interface module, a generative language model, and a search engine.

FIG. 10 is a GUI of an operating system home page, where a side panel by way of which a user is able to interact with a generative model is presented.

FIG. 11 depicts a computing device.

### DETAILED DESCRIPTION

Various technologies pertaining to integration of a generative model (such as a GLM) with an application and/or operating system are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component”, “system”, “engine”, and “module” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

When reference is made to a webpage herein, such term is intended to cover conventional webpages as well as web applications.

The technologies described herein relate to integrating a generative model with an application (such as a web browser) and/or an operating system (OS). In an example, a client computing device executes a web browser, where the web browser receives user input to retrieve a webpage. The web browser is configured to communicate with a generative model (such as a GLM). For example, upon receipt of an indication that the user desires to interact with the generative model, a side panel is presented by the web browser. The side panel can overlay a portion of the webpage being displayed by the web browser. In another example, content of the webpage is resized to accommodate the screen real estate consumed by the side panel. When the webpage is a public page (e.g., indexed by a search engine), the web browser can cause content of the webpage to be provided to the generative model. In addition, the web browser can cause other information pertaining to the web browser to be provided to the generative model, such as uniform resource locators (URLs) of webpages loaded in tabs of the browser, titles of such webpages, times when the webpages were accessed, and so forth.

In an example, based upon such information, the generative model generates suggestions and causes such suggestions to be presented as selectable “chips”. An example suggestion is “can I summarize this for you?” In another example, the user sets forth input to an input field of the side panel, and such input is provided to the generative model. The generative model generates output based upon the conversational input and the content of the webpage provided to the generative model. Accordingly, the prompt provided to the generative model includes not only the user generated input but also includes content from the webpage, information from webpages loaded in other tabs of the web browser, amongst other information. Accordingly, the output of the generative model is “grounded” in the content of the web page.

In another example, the web browser has loaded a private page, such as a webpage that includes emails of the user, a social media page, and so forth. When the web browser has such webpage loaded therein, and further when the web browser receives an indication that the user wishes to interact with the generative model, a determination is made as to whether the user has provided consent for content of the webpage to be provided to the generative model. When the user has not previously provided consent, a request is provided to the user that the user provide consent for the content of the webpage to be provided to the generative model. When the user fails to provide consent, the content of the webpage is not provided to the generative model. Contrarily, when consent of the user is received, content of the webpage is provided to the generative model such that output generated by the generative model is based upon content of the webpage. The generative model may be requested to assist with generation of text in fields of the webpage, summarizing the text, and so forth. Further, the generative model can reason over content of the webpage (public or private) and provide output. Therefore, if a webpage includes content about statistics of Babe Ruth, and with respect to the conversational input “how many home runs did Babe Ruth hit before turning 30”, the generative model can reason over content of the webpage and generate output based upon content of such web page—e.g., “Babe Ruth hit 284 home runs before turning 30”.

In still yet another example, an operating system of a computing device is configured to present a pinnable side panel on a GUI of the operating system, where a user of the computing device can interact with the generative model by way of the side panel. Therefore, an application can be executed by the computing device, such as a word processing application, a web browser, a slideshow application, etc. The application can be presenting content, and the user can readily copy and paste content displayed by way of the application into an input field in the side panel. Such content can be provided to the generative model, which can summarize the content, rewrite the content, etc., at the request of the user.

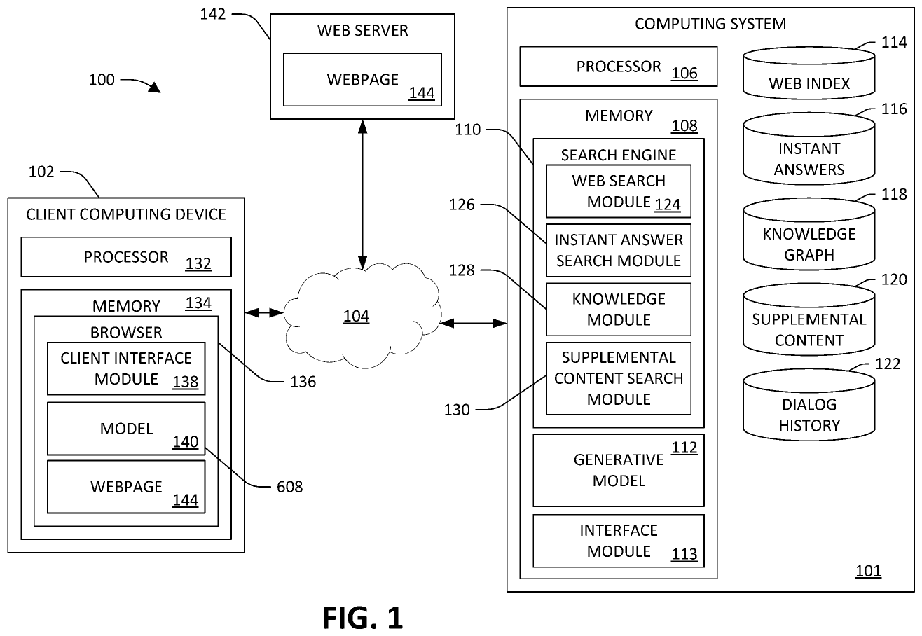

Referring now to FIG. 1, a functional block diagram of a computing environment 100 is illustrated. The computing environment 100 includes a computing system 101. While illustrated as a single system, it is to be understood that the computing system 101 can include several different server computing devices, can be distributed across data centers, etc. The computing system 101 is configured to facilitate interaction between a user and a generative model by way of a web browser (or other suitable application).

A client computing device 102 operated by a user (not shown) is in communication with the computing system 101 by way of a network 104. The client computing device 102 can be any suitable type of client computing device, such as a desktop computer, a laptop computer, a tablet (slate) computing device, a video game system, a virtual reality or augmented reality computing system, a mobile telephone, a smart speaker, or other suitable computing device.

The computing system 101 includes a processor 106 and memory 108, where the memory 108 includes instructions that are executed by the processor 106. More specifically, the memory 108 includes a search engine 110, a generative model 112, and an interface module 113 that, as will be described in greater detail below, acts as an interface between an application executing on the client computing device 102 (and/or an operating system of the client computing device 102), the search engine 110, and the generative model 112. Operations of the search engine 110, the generative model 112, and the interface module 113 are described in greater detail below. The computing system 106 also includes data stores 114-122, where the data stores 114-122 store data that is accessed by the search engine 110 and/or the generative model 112. With more particularity, the data stores 114-122 include a web index data store 114, an instant answers data store 116, a knowledge graph data store 118, a supplemental content data store 120, and a dialog history data store 122. The web index data store 114 includes a web index that indexes webpages by keywords included in or associated with the webpages. The instant answers data store 116 includes an index of instant answers that are indexed by queries, query terms, and/or terms that are semantically similar or equivalent to the queries and/or query terms. For example, the instant answer “2.16 meters” can be indexed by the query “height of Shaquille O'Neal” (and queries that are semantically similar or equivalent, such as “how tall is Shaquille O'Neal”).

The knowledge graph data store 118 includes a knowledge graph, where a knowledge graph includes data structures about entities (people, places, things, etc.) and their relationships to one another, thereby representing relationships between the entities. The search engine 110 can use the knowledge graph in connection with presenting entity cards on a search engine results page (SERP). The supplemental content data store 120 includes supplemental content, such as electronic advertisements, that can be returned by the search engine 110 based upon a query.

The dialog history data store 122 includes dialog history, where the dialog history includes dialog information with respect to users and the generative model 112. For instance, the dialog history can include, for a user, identities of conversations undertaken between the user and the generative model 112, input provided to the generative model 112 by the user for multiple dialog turns during the conversation, responses in the conversation generated by the generative model 112 in response to the inputs from the user, queries generated by the generative model 112 during the conversation that are used by the GLM 112 to generate responses, and so forth. In addition, the dialog history can include context obtained by the search engine 110 during conversations; for instance, with respect to a conversation, the dialog history 122 can include content from SERPs generated based upon queries set forth by the user and/or the generative model 112 during the conversation, content from webpages identified by the search engine 110 based upon queries set forth by the user and/or the generative model 112 during the conversation, and so forth. The data stores 114-122 are presented to show a representative sample of types of data that are accessible to the search engine 110 and/or the generative model 112; it is to be understood that there are many other sources of data that are accessible to the search engine 110 and/or the generative model 112, such as data stores that include real-time finance information, data stores that include real-time weather information, data stores that include real-time sports information, data stores that include images, data stores that include videos, data stores that include maps, etc. Such sources of information are available to the search engine 110 and/or the generative model 112.

The search engine 110 includes a web search module 124, an instant answer search module 125, a knowledge module 128, and a supplemental content search module 130. The web search module 124 is configured to search the web index data store 114 based upon queries received by users, queries generated by the search engine 110 based upon queries received by users, and/or queries generated by the generative model 112 based upon interactions of users with the generative model 112. Similarly, the instant answer search module 126 is configured to search the instant answers data store 116 based upon queries received by users, queries generated by the search engine 110 based upon queries received by users, and/or queries generated by the generative model 112 based upon interactions of users with the generative model 112. The knowledge module 128 is configured to search the knowledge graph data store 118 based upon queries received by users, queries generated by the search engine 110 based upon queries received by users, and/or queries generated by the generative model 112 based upon interactions of users with the generative model 112. Likewise, the supplemental content search module 130 is configured to search the supplemental content data store 120 based upon queries received by users, queries generated by the search engine 110 based upon queries received by users, and/or queries generated by the generative model 112 based upon interactions of users with the generative model 112.

The search engine 110 can generate structured, semi-structured, and/or unstructured data that is representative of content identified by at least one of the modules 124-130. For instance, the search engine 110 generates a JSON document that includes information obtained by the search engine 110 based upon one or more searches performed over the data stores 114-120 (or other data stores). In an example, the search engine 110 generates data that is in a structure/format that is suitable for inclusion in a prompt that is provided to the generative model 112.

The client computing device 102 includes a processor 132 and memory 134, where the memory 134 has a web browser 136 loaded therein. The web browser 136 has a client interface module 138 incorporated therein, where the web browser 136 is in communication with the interface module 113 of the computing system 101, such that the web browser 136 can exchange information with the search engine 110 and the generative model 112 by way of the client interface module 138 and the interface module 113. Optionally, the web browser 136 includes a model 140, which can be a relatively small generative model that is trained to perform fairly specific functionality that is often repeated at the web browser 136, such as text summarization and/or text completion (e.g., summarizing text displayed in a webpage and/or completing a sentence or paragraph based upon a set of words or phrases).

The environment 100 also includes a web server 142 that is in communication with the client computing device 102 by way of the network 104. The web server 142 hosts a website that includes a webpage 144. The web browser 136 is configured to retrieve webpages of the website hosted by the web server 142. Accordingly, the web browser 136 can retrieve the webpage 144 from the web server 142 (e.g., based upon user input, based upon programmatic input, etc.).

Because the generative model 112 is in communication with the web browser 136 by way of the modules 138 and 113, the generative model 112 can be provided with any suitable information that can be obtained by the web browser 136 as part of a prompt (in addition to input set forth by a user of the client computing device 102 to the generative model 112). For example, the webpage 144 retrieved by the web browser 136 can include an e-mail sent to the user. Presuming that the user has provided authorization for the generative model 112 to obtain such e-mail, in response to the web browser 136 receiving an indication that a conversation between the user and the generative model 112 is to be initiated, the web browser 136 can provide information from the webpage 144 (e.g., the email) to the generative model 112 by way of the modules 138 and 113. Specifically, at least one of the client interface module 138 or the interface module 113 is configured to structure content of the webpage in a manner that can be consumed by the generative model 112 (e.g., as at least a portion of a prompt). In addition, the web browser 136 receives input from the user and provides the interface module 113 with such input, which in turn provides such input to the generative model 112. Accordingly, the prompt provided to the generative model 112 includes not only the input set forth by the user, but additionally includes content of the webpage 144 being viewed by the user. Therefore, the generative model 112 can generate output based upon content of the web page 144.

Further, the generative model 112 can generate a query based upon the content of the webpage 144 and the input set forth by the user. The generative model 112 provides the query to the interface module 113, which in turn provides the query to the search engine 110 (in a format suitable for use by the search engine 110). The search engine 110 searches at least one of the data stores 114-120 based upon the query. The search engine 110 provides the generative 112 with at least a portion of the search results identified by the search engine 110 based upon the query (by way of the interface module 113), thereby providing additional context for the generative model 112 to employ when generating output to the user (where the output can be conversational output, an image, a video, etc.). More specifically, the prompt employed by the generative 112 to generate conversational output can additionally include at least a portion of the search results identified by the search engine 110.

Operation of the generative model 112 is improved due to the generative model 112 generating output based upon a prompt that includes content from the webpage 144 (or information about the webpage 144 determined by the search engine 110). In contrast, conventionally, generative models generate output based solely upon user input and dialog history. There are numerous use cases where the generative model 112 provides functionality that conventional generative models are unable to provide, and several of such use cases are set forth below.

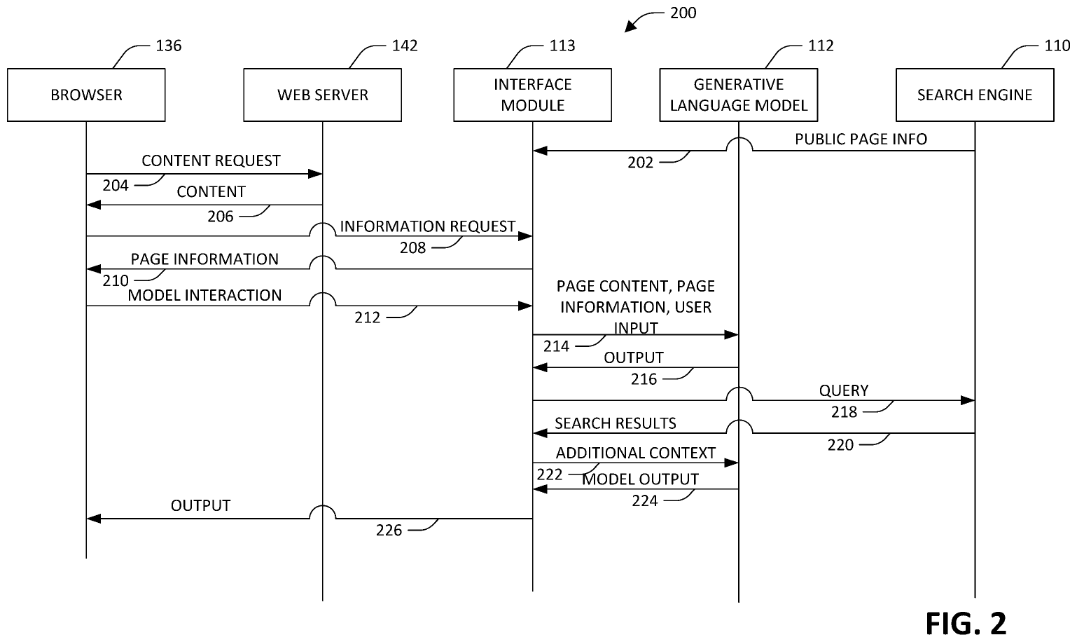

Examples of operation of the computing environment 100 are now set forth. It is to be understood that these examples are non-limiting, and permutations of such examples are contemplated. Referring to FIG. 2, a communications diagram 200 depicting communications between the web browser 136, the web server 142, the interface module 113, the GLMM 112, and the search engine 110 is illustrated. The communications diagrams presented herein illustrate exemplary methodologies relating to integration of computer-executable applications (such as web browsers, email applications, word processing applications, etc.) and/or operating systems with generative models. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

The search engine 110 can obtain information about “public” pages, where public pages are those represented in a search engine index. When indexing a webpage, for example, the search engine 110 can identify topics discussed in the webpage, entities referenced in the web page, sentiment of text in the web page (e.g., positive, negative, neutral), and so forth. At 202, public page information is provided by the search engine 110 to the interface module 113. While the search engine 110 is depicted in FIG. 2 as providing the public page information prior to the web browser 136 loading a webpage, it is understood that the interface module 113 can obtain information for a webpage in response to receiving an indication that the webpage has been loaded by the web browser 136.

At 204, the web browser 136 requests the webpage 144 from the web server 142, and at 206 the web browser 136 obtains the webpage 144 from the web server 142. At 208, the web browser 136 transmits an information request to the interface module 113, where the information request is for the public page information for the webpage 144 (provided to the interface module 113 by the search engine 110). At 210, the interface module 113 provides such page information to the web browser 136. In an example, the page information can be presented to a user by the web browser 136 upon receipt of a selection by the user of a graphical icon that corresponds to such page information.

The web browser 136 receives an indication that a user of the web browser 136 desires to interact with the generative model 112. At 212, the web browser 136 transmits an indication to the interface module 113 that the user has requested to interact with the generative model 112. In response to receiving such indication, at 214 the interface module 113 provides, for example, content of the webpage, the page information generated by the search engine 110, and/or input set forth by the user (if any). The generative model 112 generates output based upon the input provided to the generative 112 by the interface module 113 (where the input is in the in the form of a prompt). In an example, the output includes a query that is constructed to cause the search engine 110 to obtain additional information. At 216, the generative model 112 provides the output to the interface module 113, and at 218 the interface module 113 transmits the query to the search engine 110. The search engine 110 performs a search over at least one of the data stores 114-120 based upon the query and identifies search results, where the search results can include webpages identified by the search engine 110 as being relevant to the query, an instant answer, a knowledge card, and so forth. At 220, the search engine 110 provides the interface module 113 with at least some of the search results identified by the search engine 110. At 222, the interface module 113 provides the generative model 112 with additional context, where the additional context includes at least some of the search results identified by the search engine 110 (formatted in a manner that can be consumed by the generative model 112).

The generative model 112 generates model output based upon the information provided to the generative model 112 by the interface module 113. The model output can be conversational output, output to be included in a suggestion “chip”, an image, and so forth. At 224, the generative model 112 provides the interface module 113 with the model output, and at 226 the interface module 113 transmits the model output to the browser 136. The model output can be presented by the browser 136 concurrently with the webpage 144.

The communications diagram 200 illustrates that functionality of the generative model 112 is integrated into the web browser 136, and output of the generative model 112 is based upon content of at least one webpage loaded by the web browser 136 and further optionally based upon information provided by the search engine 110. In an example, the web browser 136 is configured to have a side panel where the model output is displayed, and further where the user can interact with the generative model 112 by way of an input field in the side panel.

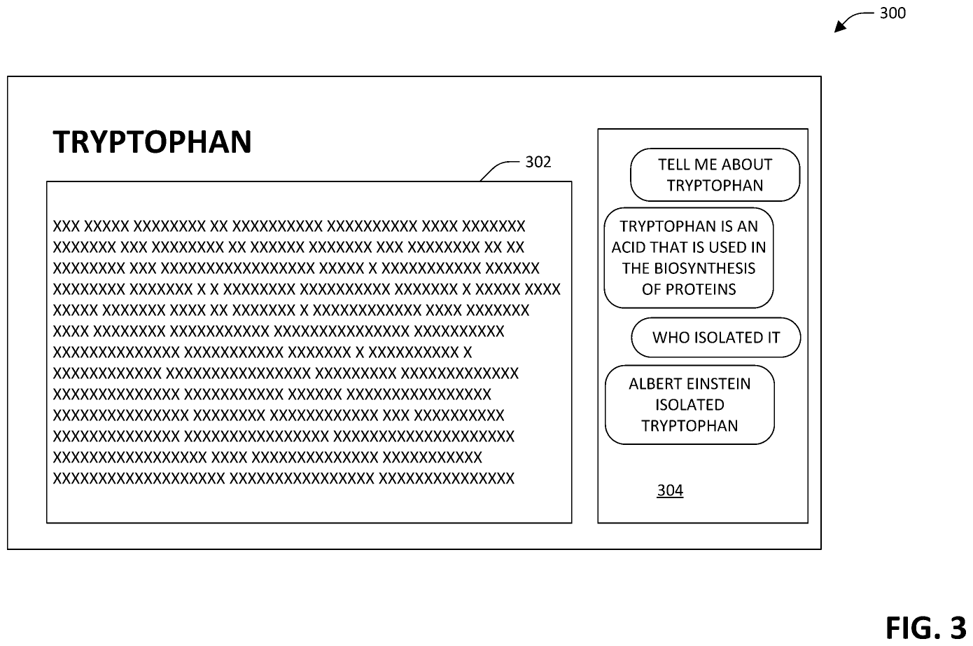

Referring now to FIG. 3, a schematic that depicts a GUI 300 of the web browser 136 is shown. In the example depicted in FIG. 3, the web browser 136 has retrieved a webpage 144 that includes textual content 302 about the acid tryptophan. The webpage 144 is public, and accordingly the search engine 110 can provide the interface module 113 with information about such webpage 144, including topics discussed in the webpage 144, entities recognized in the webpage 144, and so forth. The user of the web browser 136 can set forth an indication that the user desires to interact with the generative model 112 by way of the web browser 136. In response to receipt of such indication, the web browser 136 can cause a side panel 304 to be presented concurrently with the webpage 144. In an example, the side panel 304 is presented after receiving input from the user. In another example, the side panel 304 is presented by default.

The generative model 112 is provided with at least some of the textual content 302, the information about the web page 144 provided by the search engine 110, and/or user input. In this example, the user input is “tell me about tryptophan”. The generative model 112 generates model output based upon such input as well as the content of the webpage 144 and/or the information about the webpage 144 provided by the search engine 110.

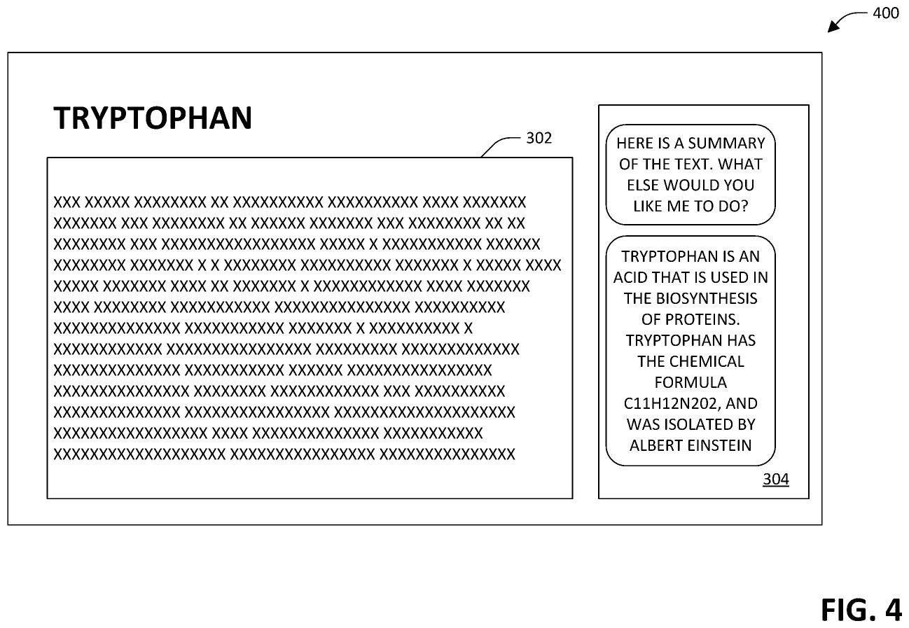

FIG. 4 depicts another GUI 400 corresponding to the webpage 144 displayed by the web browser 136. In this example GUI 400, without receiving an explicit user prompt, the generative model 112 generates a summary of the textual content 302 included in the webpage 144. Accordingly, the user can fairly quickly read the summary presented by the generative model 112 in the side panel 304 before deciding whether to read an entirety of the textual content 302. The generative model 112 may be configured to automatically provide other information, such as a description of an image included in the webpage 144, a recommendation about filling out a form on the webpage 144, and so forth.

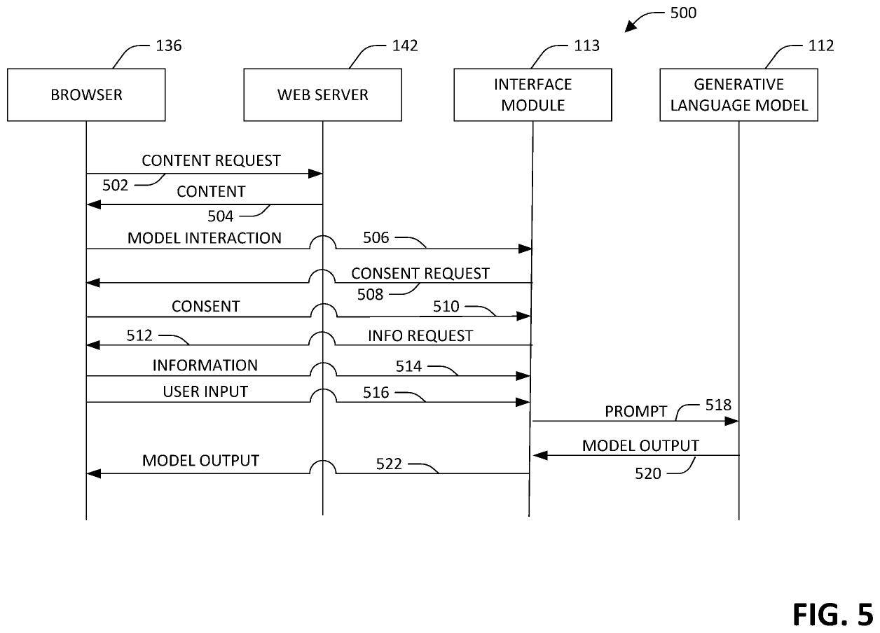

Turning to FIG. 5, another communications diagram 500 that depicts flow of communications between the web browser 136, the web server 142, the interface module 113, and the generative model 112 is shown. At 502, the web browser 136 issues a request for the webpage 144 from the web server 142. In this example, the webpage 144 is a private page, such as a page corresponding to an e-mail account of a user, a page corresponding to a social media account of a user, or other page that is not indexed by the search engine 110. At 504, the web browser 136 obtains the webpage 144 from the web server 142. The browser 136 receives an indication that the user desires to interact with the generative model 112. At 506, the web browser 136 transmits an indication that the user desires to interact with the generative model 112 to the interface module 113. The interface module 113 ascertains that the webpage 144 is a private webpage and determines whether the user has consented to providing the generative model 112 with content of the private webpage 144. When it is determined that the user has not provided such consent, the interface module 113 transmits a consent request to the web browser 136, where, for example, graphical data that indicates that consent of the user is requested is presented at the browser 136.

The user can consent to content of the webpage 144 being shared with the generative model 112, and at 510 the browser 136 transmits such consent to the interface module 113. The interface module 113 can store a record of the consent so that the user need not be requested to consent each time that the browser 136 retrieves the webpage 144. In response to receiving the consent, the interface module 113 can request information from the web browser 136. Such information can include content of the webpage 144. At 514, the web browser 136 transmits information to the interface module 113, where such information can include content of the webpage 144. At 516, optionally, when the user sets forth user input to be provided to the generative model 112 (such as textual or voice input), the browser 136 can provide such user input to the interface module 113.

The interface module 113 constructs a prompt at 518 based upon the information received by the interface module 113 at 514 and 516. The generative model 112 generates model output based upon the prompt received at 518. The model output can be conversational output, a summary of content shown on the webpage 144, and so forth. The generative model 112 transmits the model output to the interface module 113 at 520, and at 522 the interface module 113 transmits the model output to the web browser 136, whereupon the web browser 136 presents the model output together with content of the webpage 144.

It is noted that the search engine 110 is not represented in the communications diagram 500. In an example, however, the generative model 112 can generate a query based upon the prompt received at 518 and can cause such query to be provided to the search engine 110 (e.g., by way of the interface module 113). Accordingly, the prompt used by the generative model 112 to generate the model output can include information identified by the search engine 110. Moreover, as indicated previously, at least a portion of the generative model 112 may be included in the web browser 136.

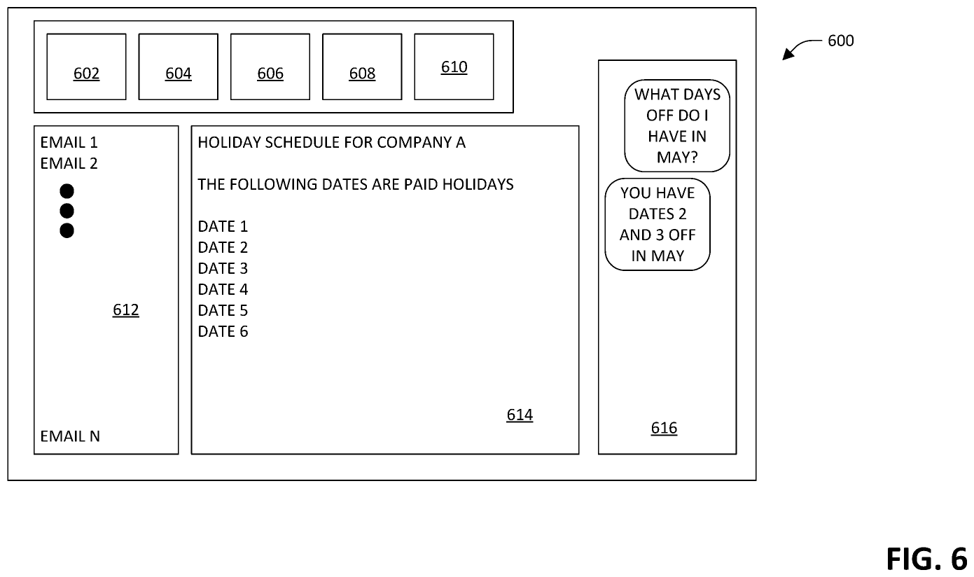

With reference now to FIG. 6, a GUI 600 of a webpage that depicts an email inbox of a user is presented. The GUI 600 can include several selectable buttons 602-610 that correspond to functionality associated with the e-mail inbox, such as a button that is associated with sending an email, a button that is associated with refreshing the inbox, and so forth. The GUI 600 may include a pane 612 that depicts a list of emails in the inbox of a user. The GUI 600 can further include a window 614 that can include content of an email being read by the user. A side panel 816 is presented by way of which the user can set forth input to the generative model 112 (e.g., as an overlay on the webpage represented in FIG. 6 or beside the webpage).

In the example shown in FIG. 6, the email in the window 614 includes information about holidays for the user over the upcoming calendar year. The user can set forth input by way of the side panel 616, and the web browser 136 transmits the input to the generative model 112 by way of the interface module 113. In addition, when user consent has been received, the web browser 136 can provide information from the email shown in the window 614 to the generative model 112 by way of the interface module 113. Therefore, the prompt used by the generative model 112 to generate conversational output includes the content of the email. As illustrated, the user has set forth the input “what days off do I have in May?” As the generative model 112 is provided with both the input and the content of the email shown in the window 614, the generative model 112 can generate output that accurately addresses the input (identifying the holidays of the user in the month of May). Conventionally, a generative model is unable to appropriately respond to such input, as the generative model does not have access to the information requested by the user.

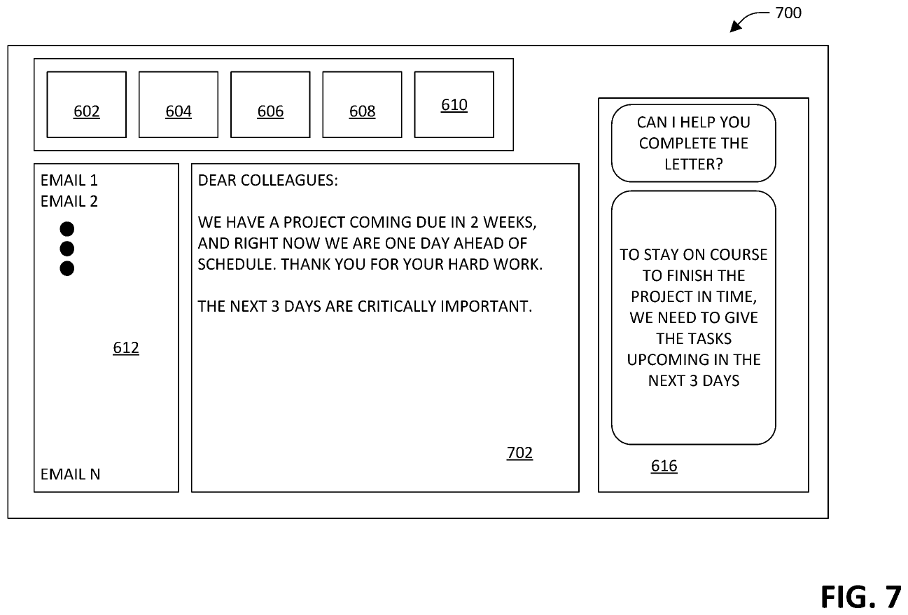

With reference now to FIG. 7, another GUI 700 of the webpage 144 that depicts the e-mail inbox of the user is presented. The webpage includes a text entry field 702 by way of which the user is setting forth textual content. The generative model 112 can be provided with such textual content by way of the interface module 113 and can also be provided with an indication that the user is setting forth such content by way of a text entry field. The generative model 112 can output a suggestion to the user based upon such content, such as “can I help you complete the e-mail”. Upon the user indicating that the assistance of the generative model 112 is desired in connection with completing the e-mail, the generative model 112 can provide a suggested completion that is editable by the user. For instance, the user can copy and paste the suggested completion into the text entry field 702 and edit such text to the liking of the user.

While various examples pertaining to the generative model 112 generating model output based upon content of webpages being presented to users have been set forth, it is noted that the generative model 112 can generate model output based upon other information accessible to the web browser 136. For example, the generative model 112 can be provided with queries that pertain to a search history of the user (e.g., to find a particular webpage in the browsing history of the user). In another example, the generative model 112 is provided with information pertaining to some most recent threshold number of tabs or pages in a current tab as context to use when generating model output. When the generative model 112 is provided with input and cannot effectively generate a suitable answer, the generative model 112 can generate queries to provide to the search engine 110 in connection with obtaining additional context to be used when generating model outputs. Further, the generative model 112 can be configured to interact with the settings of the web browser 136, such that the generative model 112 can receive input pertaining to settings of the web browser, favorites stored in the web browser, amongst other information, and can update the browser settings based upon such input. Further, as indicated previously, the generative model 112 can receive user input with respect to images or videos presented in webpages, such as “who painted that picture?” or “find the best price for the yellow one”, etc. In still yet another example, the generative model 112, with respect to a webpage, receives the conversational input “search this website for more like this”, and the generative model 112 generates a query for provision to the search engine 110 in connection with identifying similar webpages that belong to the website. According to still yet another example, the generative model 112 receives the conversational input “search for information similar to what is in this paragraph”, which can result in provision of an appropriate query to the search engine 110.

In still more specific examples, the generative model 112, with respect to a webpage, is provided with the HTML of the webpage and/or a rendered image of the webpage. The generative model 112 can be provided with the main page body as clean text. In another example, the generative model 112 is provided with information selected by the user (e.g., when the user highlights a portion of a webpage). In another example, entity extraction is undertaken on the page and the generative model 112 is provided with named entities. In connection with performing such tasks, the HTML (or image) can be converted to text and/or other models can be applied, such as object character recognition, object classifiers, image embedding models, and the like. The generative model 112 can be provided with user dialogue history and page content to generate model output. For large documents, techniques to summarize parts of the document to form a document index or techniques to send one or more chunks/snippets of the document into a limited size buffer of the generative model 112 can be utilized. The generative model 112 can output links to other webpages, and such links can cause the web browser 136 to load new pages when selected. User dialogue may be used to navigate within the page or to other pages or may be used to open pages in new tabs or in a current tab. Answers to questions or passages found for a search/find query can be highlighted in the main document pane, while the side panel may also have access to the rendered image of the main pages to allow conversation, search/find, question and answer over non text elements such as images or figures. Recent history of all main page content across multiple browser tabs can be accessible to the generative model 112 to allow very richly grounded conversations over time. Reduced representations may be stored to save memory/bandwidth and control prompt size. History can be compressed further by models that embed the data into vector representations. More contextual weight can be given to main page content that is currently scrolled into view and or where the user has spent more time viewing.

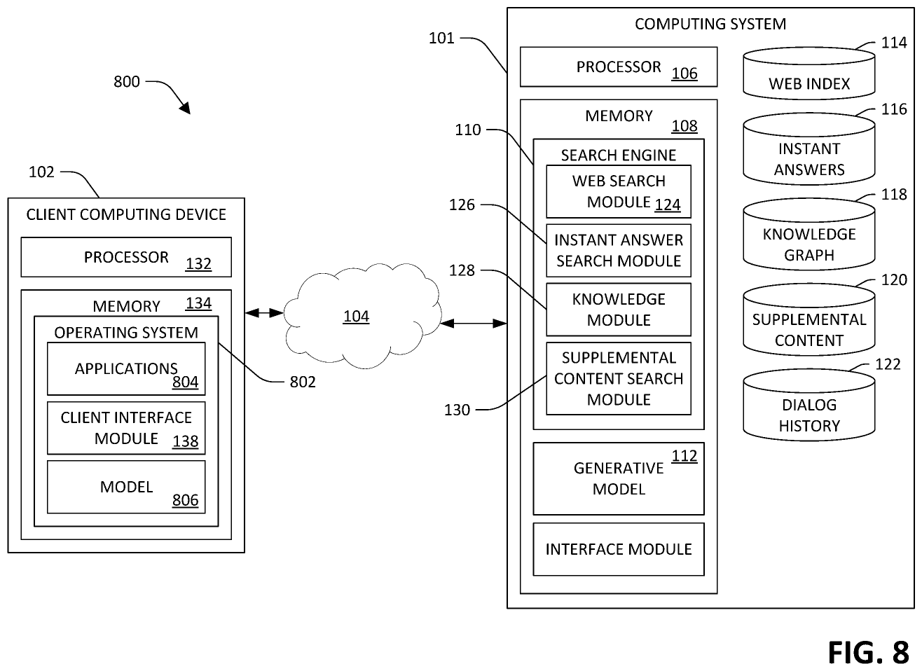

Referring now to FIG. 8, a functional block diagram of a computing environment 800 is depicted. The computing environment 800 includes the computing system 101 and the client computing device 102. The memory 134 of the client computing device 102 includes an operating system 802. The memory 134 further includes several applications 804 that are executed in conjunction with the operating system 802. Applications include the web browser 136, a word processing application, or any other suitable application. The operating system 802 further includes the client interface module 138. Optionally, the operating system 802 can also include at least a portion of a generative model.

The computing environment 800 can operate in a manner similar to the computing environment 100 depicted in FIG. 1. Instead of the client interface module 138 being included in the web browser 136, the client interface module 138 is included in the operating system 802. Accordingly, a pinnable side panel can be displayed in an operating system GUI, such that the user is provided with access to the generative model 112 regardless of the application being employed by the user. Further, the client interface module 138 can obtain contextual information pertaining to use of the client computing device 102 as tracked by the operating system 802, such as an identity of a current application being employed by the user, a length of time that the application has been active, and so forth. The interface module 113 of the computing system 101 obtains input set forth by the user by way of the side panel with respect to content presented in an application being employed by the user, and the interface module 113 constructs a prompt for provision to the generative model 112 based upon such input. The generative model 112 generates model output based upon the prompt and provides the model output to the operating system 802 of the client computing device 102 by way of the interface module 113. Additionally, as described above, the generative model 112 can generate queries based upon input received from the interface module 113 and can cause such queries to be presented to the search engine 110, which conducts searches and provides at least a portion of search results identified based upon the searches to the generative model 112. The generative model 112 can generate output based upon these identified search results.

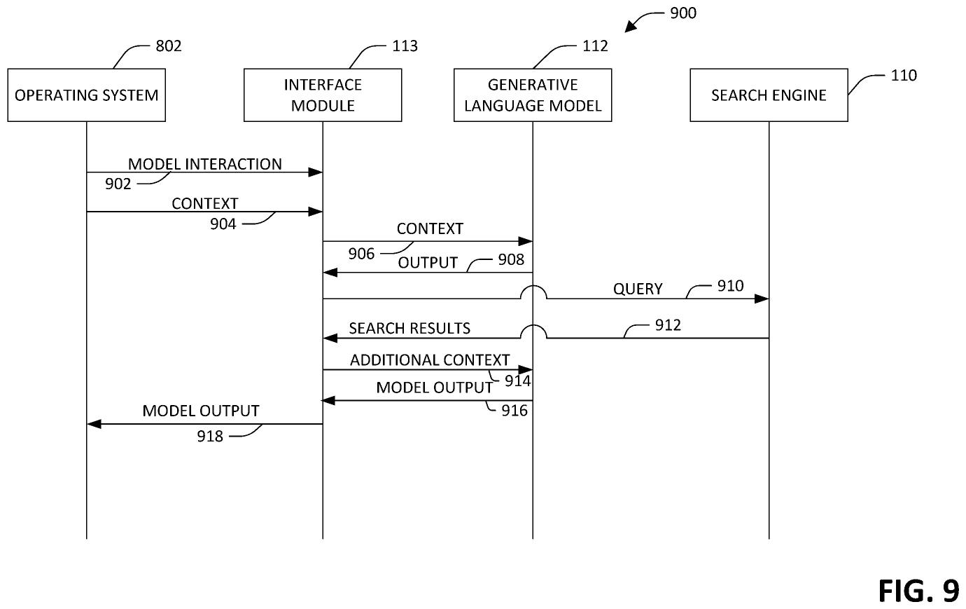

Now referring to FIG. 9, a communications diagram illustrating a flow of communications between the operating system 802, the interface module 113, the generative model 112, and the search engine 110 is presented. The user of the client computing device 102 sets forth an indication that the user intends to interact with the generative model 112, and at 902 the operating system 802 transmits an indication to the interface module 113 that the user intends to interact with the generative model 112. At 904, the operating system 802 transmits context that is to be provided to the generative model 112 to the interface module 113. The context can include an identity of an application that is active, content of such application (presuming that the operating system is able to obtain such content), etc. The context can also include user provided information, such as conversational input, content from the application that has been selected by the user for presentment to the generative model 112 (e.g., copied and pasted by the user), and so forth. At 906, the interface module 113 provides the context to the generative model 112 (formatted in a manner suitable as a prompt that can be provided as input to the generative model 112). The generative model 112 generates output based upon the context received at 906. Optionally, the output includes a query generated by the generative model 112 for provision to the search engine 110. At 908, the generative model 112 provides the output to the interface module 113, and when the output includes a query, the interface module 113 provides the query to the search engine 110 at 910. The search engine 110 conducts a search based upon the query and identifies search results. At 912, the search engine 110 provides at least some of the search results to the interface module 113, and at 914 the interface module 113 provides additional context to the generative model 112. The additional context can include at least some of the search results identified by the search engine 110 formatted in a manner suitable for consumption by the generative model 112. The generative model 112 generates model output and at 916 the generative model 112 provides the model output to the interface module 113. At 918, the interface module 113 transmits the model output to the operating system 802 for presentment to the user.

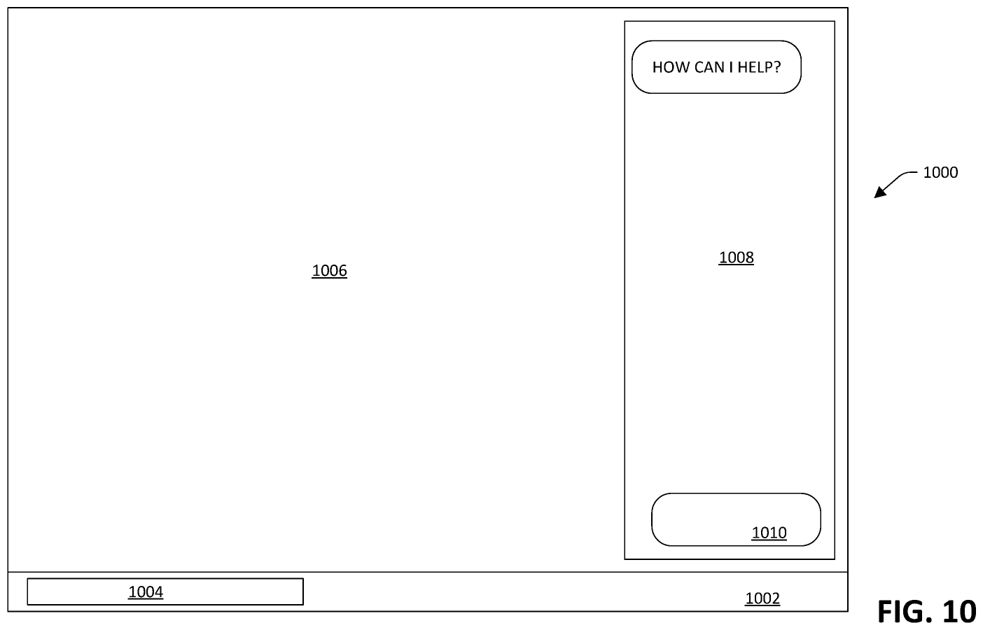

With reference now to FIG. 10, a GUI 1000 of the operating system 802 is presented. The GUI 1000 has a task bar 1002, where the taskbar 1002 includes an input field 1004 by way of which a user can set forth input. The GUI 1000 further includes a display area 1006 that can display GUIs of applications being executed by the client computing device 102, selectable icons corresponding to applications, and so forth. The GUI 1000 also includes a side panel 1008 that can be pinned in the GUI 1000 (can be opened and closed by the user). The user can interact with the generative model 112 by way of an input field 1010 in the side panel 1008. In an example, the client computing device 102 can be executing a word processing application and content of the word processing application can be displayed (text). The user can copy and paste text from the application into the input field 1010 and can cause such text to be provided to the generative model 112. This text can be used as at least a portion of a prompt; for instance, the user requests that the text be summarized, that the text be analyzed for presentment to a specific audience, and so forth.

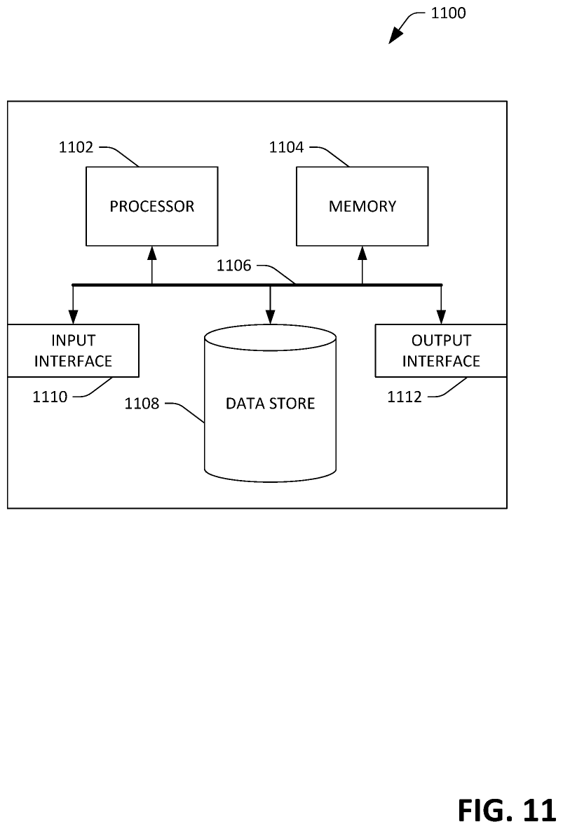

Referring now to FIG. 11, a high-level illustration of a computing device 1100 that can be used in accordance with the systems and methodologies disclosed herein is illustrated. For instance, the computing device 1100 may be used in a system that is configured to provide content displayed in a web browser as at least a portion of a prompt to a generative model. By way of another example, the computing device 1100 can be used in a system that is configured to facilitate user interaction with a generative model by way of an operating system. The computing device 1100 includes at least one processor 1102 that executes instructions that are stored in a memory 1104. The instructions may be, for instance, instructions for implementing functionality described as being carried out by one or more components discussed above or instructions for implementing one or more of the methods described above. The processor 1102 may access the memory 1104 by way of a system bus 1106. In addition to storing executable instructions, the memory 1104 may 1104 may also store prompts, images, etc.

The computing device 1100 additionally includes a data store 1108 that is accessible by the processor 1102 by way of the system bus 1106. The data store 1108 may include executable instructions, instant answers, a web index, etc. The computing device 1100 also includes an input interface 1110 that allows external devices to communicate with the computing device 1100. For instance, the input interface 1110 may be used to receive instructions from an external computer device, from a user, etc. The computing device 1100 also includes an output interface 1112 that interfaces the computing device 1100 with one or more external devices. For example, the computing device 1100 may display text, images, etc. by way of the output interface 1112.

It is contemplated that the external devices that communicate with the computing device 1100 via the input interface 1110 and the output interface 1112 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1100 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1100 may be a distributed system. Thus, for instance, several devices may be in communication by way of a network connection and may collectively perform tasks described as being performed by the computing device 1100.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Various features pertaining to integration of a generative language model into a computer-executable application are described herein in accordance with at least the following examples.

(A1) In an aspect, a method performed by a computing system includes generating a prompt that is to be input to a generative model, where the prompt includes content of a webpage being presented to the user by way of a web browser. The method also includes providing the prompt as input to the generative model. The method additionally includes receiving output from the generative model, where the generative model generated the output based upon the prompt. The method further includes causing the output to be presented to the user by way of a client computing device concurrently with the webpage being presented to the user.

(A2) In some embodiments of the method of (A1), the output is displayed in a side panel of the web browser concurrently with the web browser displaying the content of the webpage.

(A3) In some embodiments of the method of at least one of (A1)-(A2), the output is a summary of the content of the webpage.

(A4) In some embodiments of the method of (A3), the summary of the webpage is automatically generated by the generative model in response to the web browser loading the webpage.

(A5) In some embodiments of the method of at least one of (A1)-(A4), the method also includes, prior to generating the prompt, receiving input from the user, where the input from the user is set forth by way of an input field in a sidebar displayed in the web browser, wherein generating the prompt comprises including the input from the user in the prompt.

(A6) In some embodiments of the method of (A5), the method also includes providing the input from the user to the generative model, where the generative model generates a query based upon the input from the user. The method further includes providing the query generated by the generative model to a search engine, where the search engine identifies a search result based upon the query, where the prompt includes at least a portion of the search result identified by the search engine.

(A7) In some embodiments of the method of at least one of (A1)-(A6), the method also includes, prior to generating the prompt: 1) identifying that the webpage is not represented in a search engine index; and 2) upon identifying that the webpage is not represented in the search engine index, causing a request for consent to be presented concurrently on the webpage with the content, where the request for consent is configured to receive user consent to provide the content on the webpage to the generative model, where the prompt is generated subsequent to receiving the user consent.

(B1) In another aspect, a computing system includes a processor and memory, where the memory stores instructions that, when executed by the processor, cause the processor to perform at least one of the methods disclosed herein (e.g., any of the methods of (A1)-(A7)).

(C1) In yet another aspect, a computer-readable storage medium includes instructions that, when executed by a processor, cause the processor to perform at least one of the methods disclosed herein.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system comprising:
a processor; and
memory storing instructions that, when executed by the processor, cause the processor to perform acts comprising:
generating a prompt that is to be input to a generative model, where the prompt includes content of a webpage being presented to the user by way of a web browser;
providing the prompt as input to the generative model;
receiving output from the generative model, where the generative model generated the output based upon the prompt; and
causing the output to be presented to the user by way of a client computing device concurrently with the webpage being presented to the user.

2. The computing system of claim 1, where the output is displayed in a side panel of the web browser concurrently with the web browser displaying the content of the webpage.

3. The computing system of claim 1, where the output is a summary of the content of the webpage.

4. The computing system of claim 3, where the summary of the webpage is automatically generated by the generative model in response to the web browser loading the webpage.

5. The computing system of claim 1, the acts further comprising:
prior to generating the prompt, receiving input from the user, where the input from the user is set forth by way of an input field in a sidebar displayed in the web browser, wherein generating the prompt comprises including the input from the user in the prompt.

6. The computing system of claim 5, the acts further comprising:
providing the input from the user to the generative model, where the generative model generates a query based upon the input from the user; and
providing the query generated by the generative model to a search engine, where the search engine identifies a search result based upon the query, where the prompt includes at least a portion of the search result identified by the search engine.

7. The computing system of claim 1, the acts further comprising:
prior to generating the prompt:
identifying that the webpage is not represented in a search engine index; and
upon identifying that the webpage is not represented in the search engine index, causing a request for consent to be presented concurrently on the webpage with the content, where the request for consent is configured to receive user consent to provide the content on the webpage to the generative model, where the prompt is generated subsequent to receiving the user consent.

8. A method performed by a computing system, the method comprising:
generating a prompt that is to be input to a generative model, where the prompt includes content of a webpage being presented to the user by way of a web browser;
providing the prompt as input to the generative model;
receiving output from the generative model, where the generative model generated the output based upon the prompt; and
causing the output to be presented to the user by way of a client computing device concurrently with the webpage being presented to the user.

9. The method of claim 8, where the output is displayed in a side panel of the web browser concurrently with the web browser displaying the content of the webpage.

10. The method of claim 8, where the output is a summary of the content of the webpage.

11. The method of claim 10, where the summary of the webpage is automatically generated by the generative model in response to the web browser loading the webpage.

12. The method of claim 8, further comprising:
prior to generating the prompt, receiving input from the user, where the input from the user is set forth by way of an input field in a sidebar displayed in the web browser, wherein generating the prompt comprises including the input from the user in the prompt.

13. The method of claim 12, further comprising:
providing the input from the user to the generative model, where the generative model generates a query based upon the input from the user; and
providing the query generated by the generative model to a search engine, where the search engine identifies a search result based upon the query, where the prompt includes at least a portion of the search result identified by the search engine.

14. The method of claim 8, further comprising:
prior to generating the prompt:
identifying that the webpage is not represented in a search engine index; and
upon identifying that the webpage is not represented in the search engine index, causing a request for consent to be presented concurrently on the webpage with the content, where the request for consent is configured to receive user consent to provide the content on the webpage to the generative model, where the prompt is generated subsequent to receiving the user consent.

15. A computer-readable storage medium comprising instructions that, when executed by a processor, cause the processor to perform acts comprising:
generating a prompt that is to be input to a generative model, where the prompt includes content of a webpage being presented to the user by way of a web browser;
providing the prompt as input to the generative model;
receiving output from the generative model, where the generative model generated the output based upon the prompt; and
causing the output to be presented to the user by way of a client computing device concurrently with the webpage being presented to the user.

16. The computer-readable storage medium of claim 15, where the output is displayed in a side panel of the web browser concurrently with the web browser displaying the content of the webpage.

17. The computer-readable storage medium of claim 15, where the output is a summary of the content of the webpage.

18. The computer-readable storage medium of claim 17, where the summary of the webpage is automatically generated by the generative model in response to the web browser loading the webpage.

19. The computer-readable storage medium of claim 15, the acts further comprising:
prior to generating the prompt, receiving input from the user, where the input from the user is set forth by way of an input field in a sidebar displayed in the web browser, wherein generating the prompt comprises including the input from the user in the prompt.

20. The computer-readable storage medium of claim 19, the acts further comprising:
providing the input from the user to the generative model, where the generative model generates a query based upon the input from the user; and
providing the query generated by the generative model to a search engine, where the search engine identifies a search result based upon the query, where the prompt includes at least a portion of the search result identified by the search engine.
